(19) United States
(12) Patent Application Publication
(10) Pub. No.: US 2013/0027334 A1
(43) Pub. Date: Jan. 31, 2013

(54) INFORMATION INPUT DEVICE, INFORMATION INPUT DEVICE CONTROL METHOD, AND COMPUTER READABLE MEDIUM

(71) Applicant: Tatsuyoshi NOMA, Nakano-ku (JP)

(72) Inventor: Tatsuyoshi NOMA, Nakano-ku (JP)

(73) Assignee: KABUSHIKI KAISHA TOSHIBA, Tokyo (JP)

(21) Appl. No.: 13/560,443

(22) Filed: Jul. 27, 2012

(30) Foreign Application Priority Data
Jul. 28, 2011 (JP) 2011-166074

(51) Int. Cl. G06F 3/041

(52) U.S. Cl. 345/173; 178/18.01

(57) ABSTRACT

In one embodiment, there is provided an input device. The input device includes: a first sensor disposed in or near a first touch area of the input device and configured to detect an object when the object comes close to the first touch area; a second sensor disposed in or near a second touch area of the input device and configured to detect the object when the object comes close to the second touch area; and a controller configured to enable the second touch area to serve as a user operation area, when the first sensor detects the object.

### CROSS-REFERENCE TO RELATED APPLICATION

This application claims priority from Japanese Patent Application No. 2011-166074, filed on Jul. 28, 2011; the entire contents of which are hereby incorporated by reference.

### BACKGROUND

1. Field

Embodiments described herein relate to an information input device, an information input device control method, and a computer readable medium storing an information input device control program therein.

2. Description of the Related Art

Such electronic apparatus as personal computers (PCs) are now in common use. And an information input device (pointing device) such as a mouse is used when a user inputs information to such an electronic apparatus.

Information input devices such as a mouse are provided with a touch area for detecting a user touch operation as input information.

In recent years, information input devices (mice) capable of transmitting detected input information to an electronic apparatus by a wireless communication, for example, have spread. Such information input devices (mice) capable of wireless communication are advantageous in that, for example, users can use them with a high degree of freedom because users can move them without the need for paying attention to a cable.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention:

FIG. 1 illustrates transmission of information from an information input device (mouse) according to an embodiment to an electronic apparatus (notebook PC);

FIG. 2 is a block diagram showing the configuration of the notebook PC according to the embodiment;

FIGS. 3A-3C illustrate the configuration and operations of the mouse according to the embodiment which is equipped with two proximity sensors;

FIGS. 4A-4C illustrate the configuration and operations of a mouse according to another embodiment which is equipped with two proximity sensors;

FIGS. 5A-5C illustrate the configuration and operations of a mouse according to still another embodiment which is equipped with two proximity sensors;

FIG. 6 shows the configuration of a mouse according to yet another embodiment which is equipped with four proximity sensors;

FIGS. 7A-7D illustrate operations of the mouse of FIG. 6;

FIGS. 8A-8C illustrate the configuration and left-hand operation mode operations of a mouse according to a further embodiment which is equipped with two proximity sensors;

FIG. 9 is a flowchart of a process which is executed by each of the mice having two proximity sensors; and

FIG. 10 is a flowchart of a process which is executed by the mouse having four proximity sensors.

### DETAILED DESCRIPTION

According to exemplary embodiments of the present invention, there is provided an input device. The input device includes: a first sensor disposed in or near a first touch area of the input device and configured to detect an object when the object comes close to the first touch area; a second sensor disposed in or near a second touch area of the input device and configured to detect the object when the object comes close to the second touch area; and a controller configured to enable the second touch area to serve as a user operation area, when the first sensor detects the object.

Embodiments of the present invention will be hereinafter described with reference to the drawings.

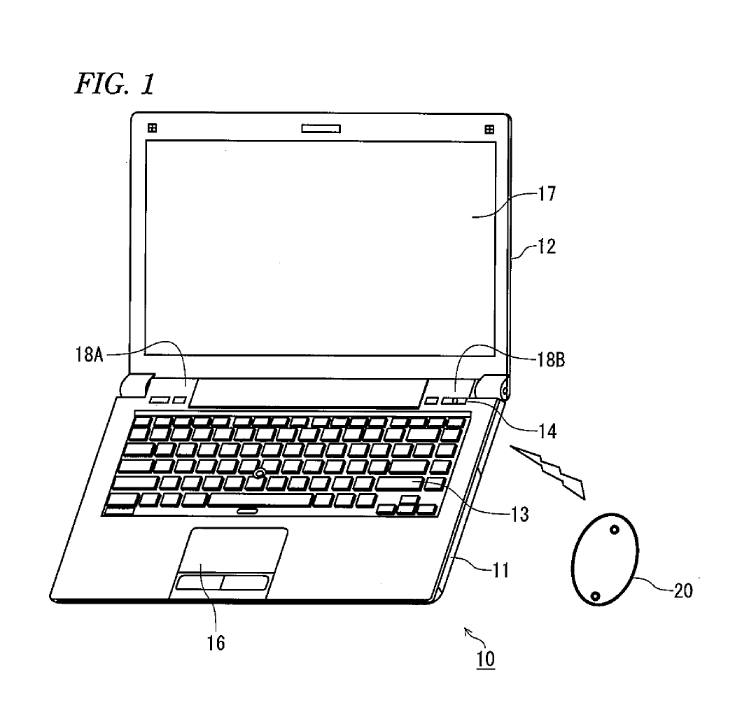

FIG. 1 illustrates transmission of information from an information input device (mouse) according to an embodiment to an electronic apparatus (notebook PC). In this embodiment, as shown in FIG. 1, when the mouse 20 is manipulated by the user, user input information is transmitted from the mouse 20 to the notebook PC 10 by a wireless communication. The notebook PC 10 receives the transmitted user input information and operates according to it.

The mouse 20 is provided with touch areas for detecting a user touch operation as input information, and transmits user input information detected by the touch area by a wireless communication.

The application field of the invention is not limited to notebook PCs, and the invention can also be applied to TV receivers, cell phones, portable electronic apparatus, etc.

As shown in FIG. 1, the notebook PC 10 is composed of a computer main body 11 and a video display 12. The video display 12 incorporates an LCD (liquid crystal display) 17, for example.

The video display 12 is attached to the computer main body 11 so as to be rotatable between an open position where it exposes the top surface of the computer main body 11 and a closed position where it covers the top surface of the computer main body 11.

The computer main body 11 has a thin, box-shaped cabinet, and its top surface is provided with a keyboard 13, a power button 14 for powering on and off the notebook PC 10, a touch pad 16, speakers 18A and 18B, etc.

The right-hand side surface, for example, of the computer main body 11 is provided with a USB connector (not shown) to which a USB cable or a USB device that complies with the USB (universal serial bus) 2.0 standard is to be connected.

The back surface of the computer main body 11 is provided with an external display connection terminal (not shown) that complies with the HDMI (high-definition multimedia interface) standard, for example. The external display connection terminal is used for outputting a digital video signal to an external display.

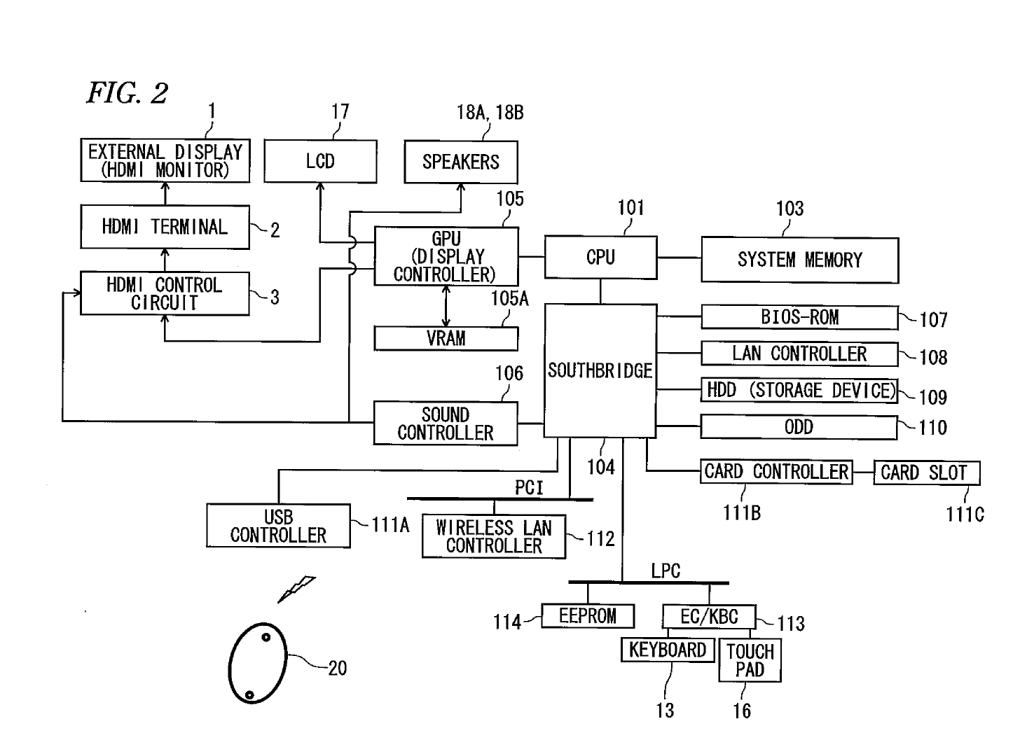

FIG. 2 is a block diagram showing the configuration of the notebook PC 10 according to the embodiment. As shown in FIG. 2, the notebook PC 10 is equipped with a CPU (central processing unit) 101, a system memory 103, a southbridge 104, a GPU (graphics processing unit) 105, a VRAM (video random access memory) 105A, a sound controller 106, a BIOS-ROM (basic input/output system-read only memory) 107, a LAN (local area network) controller 108, a hard disk drive (HDD; storage device) 109, an optical disc drive (ODD) 110, a USB controller 111A, a card controller 111B, a card slot 111C, a wireless LAN controller 112, an embedded controller/keyboard controller (EC/KBC) 113, an EEPROM (electrically erasable programmable ROM) 114, etc.

The CPU 101 is a processor which controls operations of individual components of the notebook PC 10. The CPU 101 runs a BIOS which is stored in the BIOS-ROM 107. The BIOS is programs for hardware control. The CPU 101 incorporates a memory controller for access-controlling the system memory 103. The CPU 101 also has a function of performing a communication with the GPU 105 via, for example, a serial bus that complies with the PCI Express standard.

The GPU 105 is a display controller which controls the LCD 17 which is used as a display monitor of the notebook PC 10. A display signal generated by the GPU 105 is sent to the LCD 17. The GPU 105 can also send a digital video signal to an external display 1 via an HDMI control circuit 3 and an HDMI terminal 2.

The HDMI terminal 2 is the above-mentioned external display connection terminal. The HDMI terminal 2 can send a non-compressed digital video signal and digital audio signal to the external display 1 such as a TV receiver via a single cable. The HDMI control circuit 3 is an interface for sending a digital video signal to the external display 1 (called an HDMI monitor) via the HDMI terminal 2.

The southbridge 104 controls the individual devices on a PCI (peripheral component interconnect) bus and the individual devices on an LPC (low pin count) bus. The southbridge 104 incorporates an IDE (integrated drive electronics) controller for controlling the HDD 109 and the ODD 110.

The southbridge 104 also has a function of performing a communication with the sound controller 106.

The sound controller 106, which is a sound source device, outputs reproduction subject audio data to the speakers 18A and 18B or the HDMI control circuit 3. The LAN controller 108 is a wired communication device which performs a wired communication according to the IEEE 802.3 standard, for example. On the other hand, the wireless LAN controller 112 is a wireless communication device which performs a wireless communication according to the IEEE 802.11g standard, for example. The USB controller 111A performs a communication with an external device which complies with the USB 2.0 standard, for example.

For example, the USB controller 111A is used for receiving an image data file from a digital camera. The card controller 111B writes and reads data to and from a memory card such as an SD card that is inserted in a card slot 111C that is formed in the computer main body 11.

The EC/KBC 113 is a one-chip microcomputer in which an embedded controller for power management and a keyboard controller for controlling the keyboard 13 and the touch pad 16 are integrated together. The EC/KBC 113 has a function of powering on or off the notebook PC 10 in response to a user operation of the power button 14.

In the embodiment, display control is performed in such a manner that, for example, the CPU 101 runs a program that is stored in the system memory 103, the HDD 109, or the like.

Although not shown in FIG. 2, for example, a wireless communication receiving unit capable of receiving a wireless communication signal transmitted from the mouse 20 is connected to the USB controller 111A and receives input information that is transmitted from the mouse 20 by a wireless communication. The notebook PC 10 operates according to the received input information.

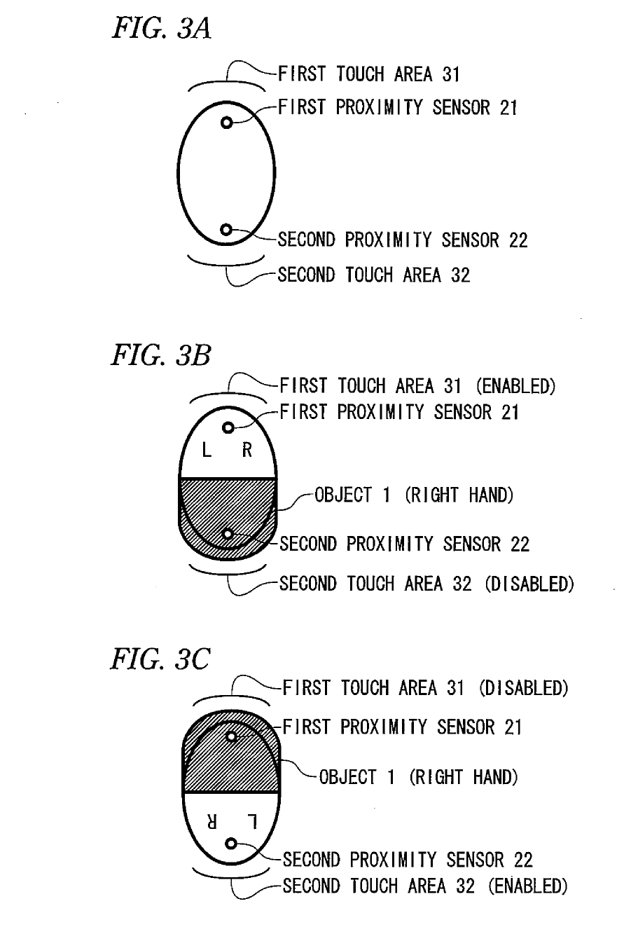

FIGS. 3A-3C illustrate the configuration and operations of the mouse 20 according to the embodiment which is equipped with two proximity sensors. In the embodiment, it is set in the notebook PC 10 in advance that if an object is detected by one of the proximity sensors the user will manipulate the mouse 20 with his or her right hand.

Proximity sensors that can be used in the embodiment will be described below. Proximity sensors are sensors for detecting an object without contacting the object. Proximity sensors are classified according to the principle of operation into a high-frequency oscillation type utilizing electromagnetic induction, a magnetic type using a magnet, a capacitive type utilizing a variation in capacitance, an eddy current type utilizing eddy current which is generated in a metal body to be detected through electromagnetic induction, etc.

The magnetic proximity sensor reacts to a magnetic body when it comes close to the magnetic proximity sensor. The magnetic proximity sensor is used for measurement of a rotor speed, turning on/off of a circuit, and counting of the numbers of rotations of a motor and a wheel, and is also used as a position sensor.

An optical proximity sensor (photosensor) is composed of a light source called an emitter and a photodetector for detecting presence/absence of light. In general, the photodetector is a phototransistor and the emitter is an LED (light-emitting diode). The optical proximity sensor is applied to many fields including an optical encoder.

An ultrasonic proximity sensor detects the position of an object by emitting high-frequency ultrasonic waves (in general, around 200 kHz), receiving ultrasonic waves that are reflected by the object, and measuring a time taken from the emission to the reception of the ultrasonic waves.

An inductive proximity sensor is used for detecting a conductor such as a metal body. An AC magnetic field is generated by a detection coil and an impedance variation due to eddy current occurring in a metal body (detection subject body) is detected.

The capacitive proximity sensor reacts to an object whose relative permittivity is larger than 1.2. A substance provided inside the sensor operates as a capacitor, and the total capacitance component of a probe of the sensor is increased. The capacitance increase becomes an activation signal for an internal oscillator, and the internal oscillator sends an output signal. The capacitive proximity sensor can detect non-metallic objects such as wood, a liquid, and a chemical material.

As for the eddy current proximity sensor, when a conductor is located in a varying magnetic field, electromotive force is generated in the conductor and eddy current flows there. The eddy current proximity sensor is mainly used for detection of a conductive substance and also used for nondestructive tests relating to the thickness, the distance, a break, etc. of substances.

In the embodiment, one of the above kinds of proximity sensors is used as appropriate.

FIG. 3A shows the configuration of the mouse 20 according to the embodiment. As shown in FIG. 3A, the mouse 20 is equipped with two proximity sensors, that is, a first proximity sensor 21 and a second proximity sensor 22.

As described later, the mouse 20 is provided with two areas (touch areas), that is, a first touch area 31 and a second touch area 32, which perform different operations.

The mouse 20 according to the embodiment is equipped with a controller such as a CPU (not shown).

The first proximity sensor 21 is disposed in or in the vicinity of the first touch area 31 and detects an object that is located close to the mouse 20. Likewise, the second proximity sensor 22 is disposed in or in the vicinity of the second touch area 32 and detects an object that is located close to the mouse 20.

If an object is detected by the first proximity sensor 21, the controller enables the second touch area 32 and disables the first touch area 31.

FIG. 3B illustrates an operation that is performed when the user's right hand to manipulate the mouse 20 comes close to the mouse 20 and is detected as an object 1 by the second proximity sensor 22.

As mentioned above, in the embodiment, it is set in the notebook PC 10 in advance that if an object is detected by the second proximity sensor 22 the user will manipulate the mouse 20 with his or her right hand.

FIG. 3B shows a state that the object 1 has been detected by the second proximity sensor 22. In this case, the first touch area 31 is enabled and the second touch area 32 is disabled.

As shown in FIG. 3B, touch sensors L and R are rendered operational in the enabled first touch area 31. The touch sensor L corresponds to the left-hand area of the first touch area 31 of the mouse 20 which is set for the right hand, that is, an area to be usually manipulated by the index finger of the right hand. The touch sensor R corresponds to the right-hand area of the first touch area 31, that is, an area to be usually manipulated by the middle finger of the right hand.

FIG. 3C illustrates an operation that is performed when the user's right hand to manipulate the mouse 20 comes close to the mouse 20 and is detected as an object 1 by the first proximity sensor 21.

As mentioned above, in the embodiment, it is set in the notebook PC 10 in advance that if an object is detected by the first proximity sensor 21 the user will manipulate the mouse 20 with his or her right hand.

FIG. 3C shows a state that the object 1 has been detected by the first proximity sensor 21. In this case, the second touch area 32 is enabled and the first touch area 31 is disabled.

As shown in FIG. 3C, as in the case of FIG. 3B, touch sensors L and R are rendered operational in the enabled second touch area 32. The touch sensor L corresponds to the left-hand area of the second touch area 32 of the mouse 20 which is set for the right hand, that is, an area to be usually manipulated by the index finger of the right hand. The touch sensor R corresponds to the right-hand area of the second touch area 32, that is, an area to be usually manipulated by the middle finger of the right hand.

As shown in FIGS. 3A-3C, the above configuration makes it possible to provide a mouse which can be used in plural (two) orientations.

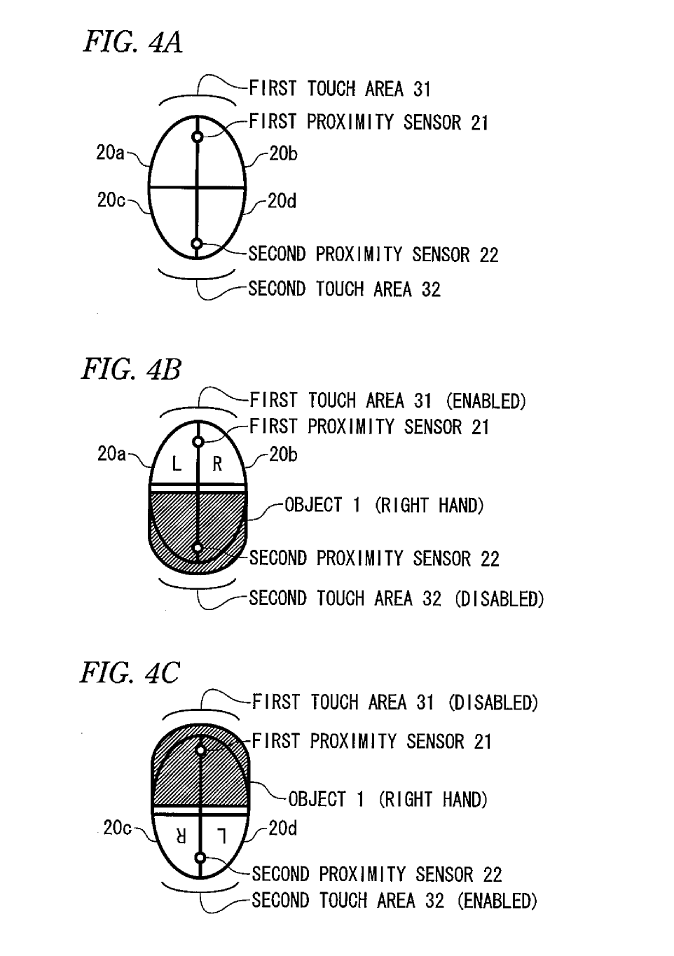

FIGS. 4A-4C illustrate the configuration and operations of a mouse 20 according to another embodiment which is equipped with two proximity sensors. In this embodiment, a first touch area 31 is divided into two areas 20a and 20b and a second touch area 32 is divided into two areas 20c and 20d.

In this embodiment, as in the embodiment of FIGS. 3A-3C, it is set in the notebook PC 10 in advance that if an object is detected by one of the proximity sensors the user will manipulate the mouse 20 with his or her right hand.

FIG. 4A shows the configuration of the mouse 20 according to the embodiment. As shown in FIG. 4A, the mouse 20 is equipped with two proximity sensors, that is, a first proximity sensor 21 and a second proximity sensor 22.

As described later, the mouse 20 is provided with two areas (touch areas), that is, a first touch area 31 and a second touch area 32, which perform different operations. As shown in FIG. 4A, each of the first touch area 31 and the second touch area 32 is divided into the two areas.

Also in this embodiment, the mouse 20 is equipped with a controller such as a CPU (not shown).

The first proximity sensor 21 is disposed in or in the vicinity of the first touch area 31 and detects an object that is located close to the mouse 20. Likewise, the second proximity sensor 22 is disposed in or in the vicinity of the second touch area 32 and detects an object that is located close to the mouse 20.

If an object is detected by the first proximity sensor 21, the controller enables the second touch area 32 and disables the first touch area 31.

FIG. 4B illustrates an operation that is performed when the user's right hand to manipulate the mouse 20 comes close to the mouse 20 and is detected as an object 1 by the second proximity sensor 22.

As mentioned above, in the embodiment, it is set in the notebook PC 10 in advance that if an object is detected by the second proximity sensor 22 the user will manipulate the mouse 20 with his or her right hand.

FIG. 4B shows a state that the object 1 has been detected by the second proximity sensor 22. In this case, the first touch area 31 is enabled and the second touch area 32 is disabled.

As shown in FIG. 4B, touch sensors L and R are rendered operational in the respective areas 20a and 20b of the enabled first touch area 31. The touch sensor L corresponds to the left-hand area 20a of the first touch area 31 of the mouse 20 which is set for the right hand, that is, an area to be usually manipulated by the index finger of the right hand. The touch sensor R corresponds to the right-hand area 20b of the first touch area 31, that is, an area to be usually manipulated by the middle finger of the right hand.

FIG. 4C illustrates an operation that is performed when the user's right hand to manipulate the mouse 20 comes close to the mouse 20 and is detected as an object 1 by the first proximity sensor 21.

As mentioned above, in the embodiment, it is set in the notebook PC 10 in advance that if an object is detected by the first proximity sensor 21 the user will manipulate the mouse 20 with his or her right hand.

FIG. 4C shows a state that the object 1 has been detected by the first proximity sensor 21. In this case, the second touch area 32 is enabled and the first touch area 31 is disabled.

As shown in FIG. 4C, as in the case of FIG. 4B, touch sensors L and R are rendered operational in the respective areas 20d and 20c of the enabled second touch area 32. The touch sensor L corresponds to the left-hand area 20d of the second touch area 32 of the mouse 20 which is set for the right hand, that is, an area to be usually manipulated by the index finger of the right hand. The touch sensor R corresponds to the right-hand area 20c of the second touch area 32, that is, an area to be usually manipulated by the middle finger of the right hand.

As shown in FIGS. 4A-4C, the above configuration makes it possible to provide a mouse which can be used in plural (two) orientations.

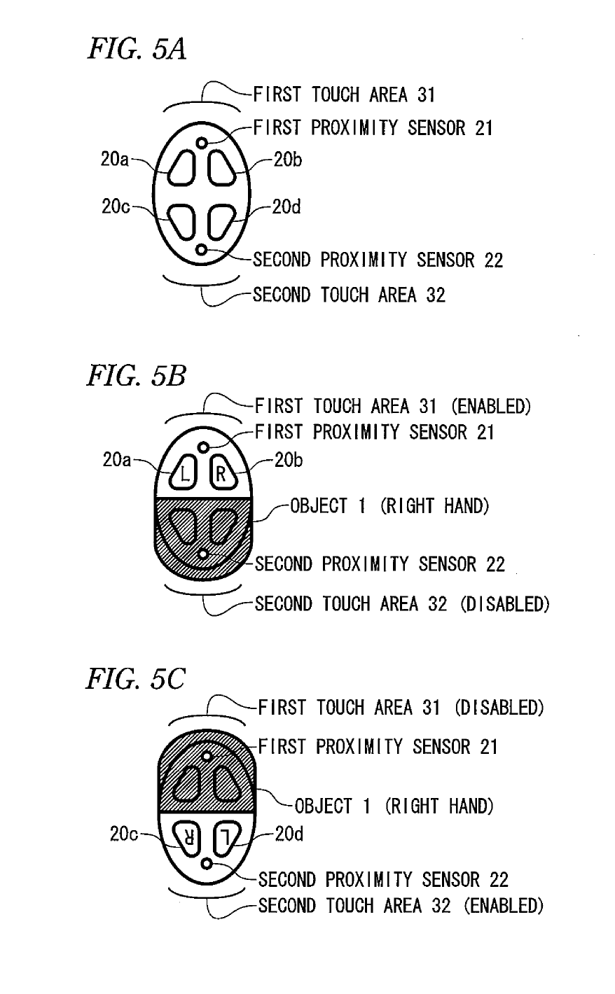

FIGS. 5A-5C illustrate the configuration and operations of a mouse 20 according to still another embodiment which is equipped with two proximity sensors. In this embodiment, a first touch area 31 is provided with two touch areas 20a and 20b and a second touch area 32 is provided with two touch areas 20c and 20d.

In this embodiment, as in the above embodiments, it is set in the notebook PC 10 in advance that if an object is detected by one of the proximity sensors the user will manipulate the mouse 20 with his or her right hand.

FIG. 5A shows the configuration of the mouse 20 according to the embodiment. As shown in FIG. 5A, the mouse 20 is equipped with two proximity sensors, that is, a first proximity sensor 21 and a second proximity sensor 22.

As described later, the mouse 20 is provided with two areas (touch areas), that is, a first touch area 31 and a second touch area 32, which perform different operations. As shown in FIG. 5A, each of the first touch area 31 and the second touch area 32 is provided with the two areas.

Also in this embodiment, the mouse 20 is equipped with a controller such as a CPU (not shown).

The first proximity sensor 21 is disposed in or in the vicinity of the first touch area 31 and detects an object that is located close to the mouse 20. Likewise, the second proximity sensor 22 is disposed in or in the vicinity of the second touch area 32 and detects an object that is located close to the mouse 20.

If an object is detected by the first proximity sensor 21, the controller enables the second touch area 32 and disables the first touch area 31.

FIG. 5B illustrates an operation that is performed when the user's right hand to manipulate the mouse 20 comes close to the mouse 20 and is detected as an object 1 by the second proximity sensor 22.

As mentioned above, in the embodiment, it is set in the notebook PC 10 in advance that if an object is detected by the second proximity sensor 22 the user will manipulate the mouse 20 with his or her right hand.

FIG. 5B shows a state that the object 1 has been detected by the second proximity sensor 22. In this case, the first touch area 31 is enabled and the second touch area 32 is disabled.

As shown in FIG. 5B, touch sensors L and R are rendered operational in the respective touch areas 20a and 20b of the enabled first touch area 31. The touch sensor L corresponds to the left-hand touch area 20a of the first touch area 31 of the mouse 20 which is set for the right hand, that is, an area to be usually manipulated by the index finger of the right hand. The touch sensor R corresponds to the right-hand touch area 20b of the first touch area 31, that is, an area to be usually manipulated by the middle finger of the right hand.

FIG. 5C illustrates an operation that is performed when the user's right hand to manipulate the mouse 20 comes close to the mouse 20 and is detected as an object 1 by the first proximity sensor 21.

As mentioned above, in the embodiment, it is set in the notebook PC 10 in advance that if an object is detected by the first proximity sensor 21 the user will manipulate the mouse 20 with his or her right hand.

FIG. 5C shows a state that the object 1 has been detected by the first proximity sensor 21. In this case, the second touch area 32 is enabled and the first touch area 31 is disabled.

As shown in FIG. 5C, as in the case of FIG. 5B, touch sensors L and R are rendered operational in the respective touch areas 20d and 20c of the enabled second touch area 32. The touch sensor L corresponds to the left-hand touch area 20d of the second touch area 32 of the mouse 20 which is set for the right hand, that is, an area to be usually manipulated by the index finger of the right hand. The touch sensor R corresponds to the right-hand area 20c of the second touch area 32, that is, an area to be usually manipulated by the middle finger of the right hand.

As shown in FIGS. 5A-5C, the above configuration makes it possible to provide a mouse which can be used in plural (two) orientations.

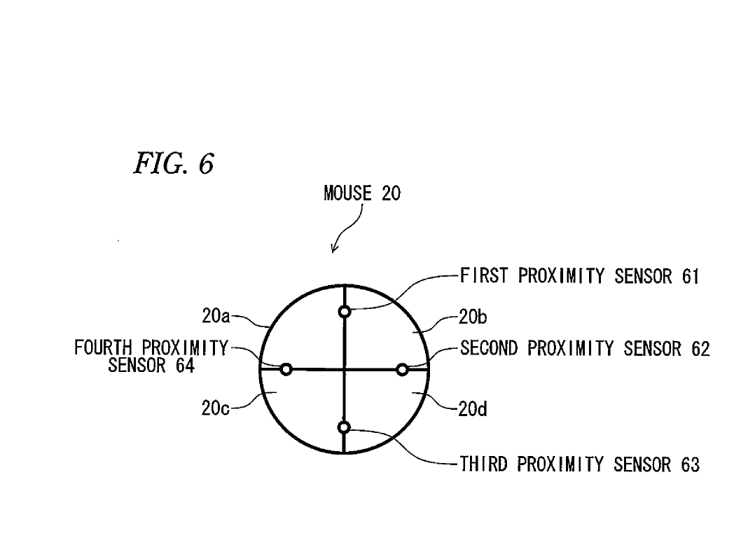

FIG. 6 shows the configuration of a mouse 20 according to yet another embodiment which is equipped with four proximity sensors, that is, a first proximity sensor 61, a second proximity sensor 62, a third proximity sensor 63, and a fourth proximity sensor 64.

In this embodiment, as shown in FIG. 6, four touch areas, for example, are formed. Two touch areas located on both sides of one proximity sensor correspond to a touch area as defined in each of the above embodiments. That is, in the embodiment, if an object is detected by, for example, the third proximity sensor 63, two touch areas 20a and 20b located on both sides of the first proximity sensor 61 serve as a touch area as defined in each of the above embodiments.

Likewise, if an object is detected by the fourth proximity sensor 64, two touch areas 20b and 20d located on both sides of the second proximity sensor 62 serve as a touch area as defined in each of the above embodiments.

If an object is detected by the first proximity sensor 61, two touch areas 20d and 20c located on both sides of the third proximity sensor 63 serve as a touch area as defined in each of the above embodiments.

If an object is detected by the second proximity sensor 62, two touch areas 20c and 20a located on both sides of the fourth proximity sensor 64 serve as a touch area as defined in each of the above embodiments.

As in the above embodiments, it is set in the notebook PC 10 in advance that if an object is detected by one of the proximity sensors 61-64 the user will manipulate the mouse 20 with his or her right hand.

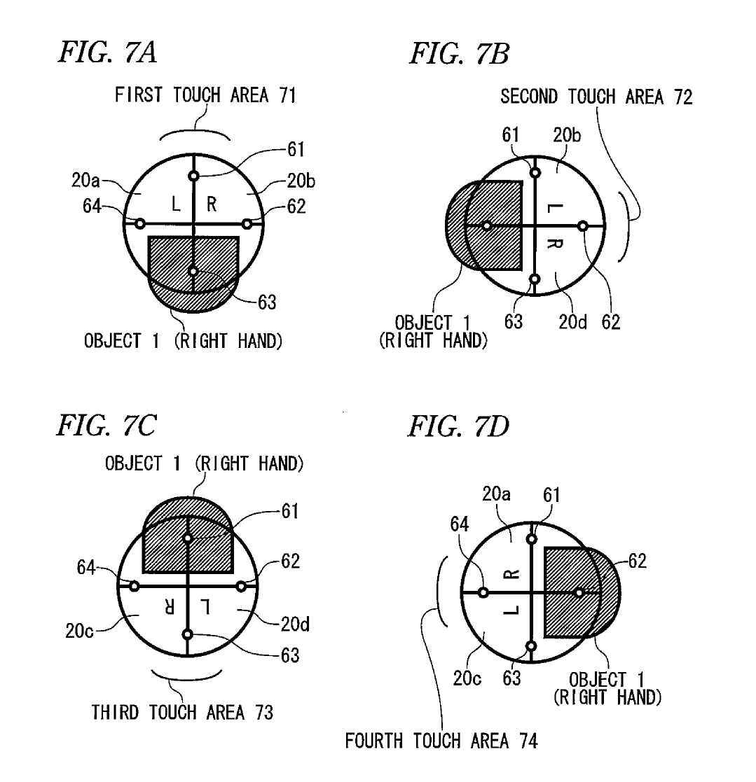

FIG. 7A-7D illustrate operations of the mouse 20 of FIG. 6 which has the four proximity sensors 61-64.

FIG. 7A illustrates an operation that is performed when the user's right hand to manipulate the mouse 20 comes close to the mouse 20 and is detected as an object 1 by the third proximity sensor 63.

As mentioned above, in the embodiment, it is set in the notebook PC 10 in advance that if an object is detected by the second proximity sensor 63 the user will manipulate the mouse 20 with his or her right hand.

FIG. 7A shows a state that the object 1 has been detected by the third proximity sensor 63. In this case, a first touch area 71 (consisting of the touch areas 20a and 20b located on both sides of the first proximity sensor 61 which is opposed to the third proximity sensor 63) is enabled and the touch area opposed to the first touch area 71 disabled.

A touch sensor L corresponds to the left-hand touch area 20a of the first touch area 71 of the mouse 20 which is set for the right hand, that is, an area to be usually manipulated by the index finger of the right hand. A touch sensor R corresponds to the right-hand touch area 20b of the first touch area 71, that is, an area to be usually manipulated by the middle finger of the right hand.

FIG. 7B illustrates an operation that is performed when the user's right hand to manipulate the mouse 20 comes close to the mouse 20 and is detected as an object 1 by the fourth proximity sensor 64.

As mentioned above, in the embodiment, it is set in the notebook PC 10 in advance that if an object is detected by the fourth proximity sensor 64 the user will manipulate the mouse 20 with his or her right hand.

FIG. 7B shows a state that the object 1 has been detected by the fourth proximity sensor 64. In this case, a second touch area 72 (consisting of the touch areas 20b and 20d located on both sides of the second proximity sensor 62 which is opposed to the fourth proximity sensor 64) is enabled and the touch area opposed to the second touch area 72 disabled.

A touch sensor L corresponds to the left-hand touch area 20b of the second touch area 72 of the mouse 20 which is set for the right hand, that is, an area to be usually manipulated by the index finger of the right hand. A touch sensor R corresponds to the right-hand touch area 20d of the second touch area 72, that is, an area to be usually manipulated by the middle finger of the right hand.

FIG. 7C illustrates an operation that is performed when the user's right hand to manipulate the mouse 20 comes close to the mouse 20 and is detected as an object 1 by the first proximity sensor 61.

As mentioned above, in the embodiment, it is set in the notebook PC 10 in advance that if an object is detected by the first proximity sensor 64 the user will manipulate the mouse 20 with his or her right hand.

FIG. 7C shows a state that the object 1 has been detected by the first proximity sensor 61. In this case, a third touch area 73 (consisting of the touch areas 20d and 20c located on both sides of the third proximity sensor 63 which is opposed to the first proximity sensor 61) is enabled and the touch area opposed to the third touch area 73 disabled.

A touch sensor L corresponds to the left-hand touch area 20d of the third touch area 73 of the mouse 20 which is set for the right hand, that is, an area to be usually manipulated by the index finger of the right hand. A touch sensor R corresponds to the right-hand touch area 20c of the third touch area 73, that is, an area to be usually manipulated by the middle finger of the right hand.

FIG. 7D illustrates an operation that is performed when the user's right hand to manipulate the mouse 20 comes close to the mouse 20 and is detected as an object 1 by the second proximity sensor 62.

As mentioned above, in the embodiment, it is set in the notebook PC 10 in advance that if an object is detected by the second proximity sensor 62 the user will manipulate the mouse 20 with his or her right hand.

FIG. 7D shows a state that the object 1 has been detected by the second proximity sensor 62. In this case, a fourth touch area 74 (consisting of the touch areas 20c and 20a located on both sides of the fourth proximity sensor 64 which is opposed to the second proximity sensor 62) is enabled and the touch area opposed to the fourth touch area 74 disabled.

A touch sensor L corresponds to the left-hand touch area 20c of the fourth touch area 74 of the mouse 20 which is set for the right hand, that is, an area to be usually manipulated by the index finger of the right hand. A touch sensor R corresponds to the right-hand touch area 20a of the fourth touch area 74, that is, an area to be usually manipulated by the middle finger of the right hand.

As shown in FIGS. 7A-7D, with the above configuration, this embodiment makes it possible to provide a mouse which can be used in plural (four) orientations.

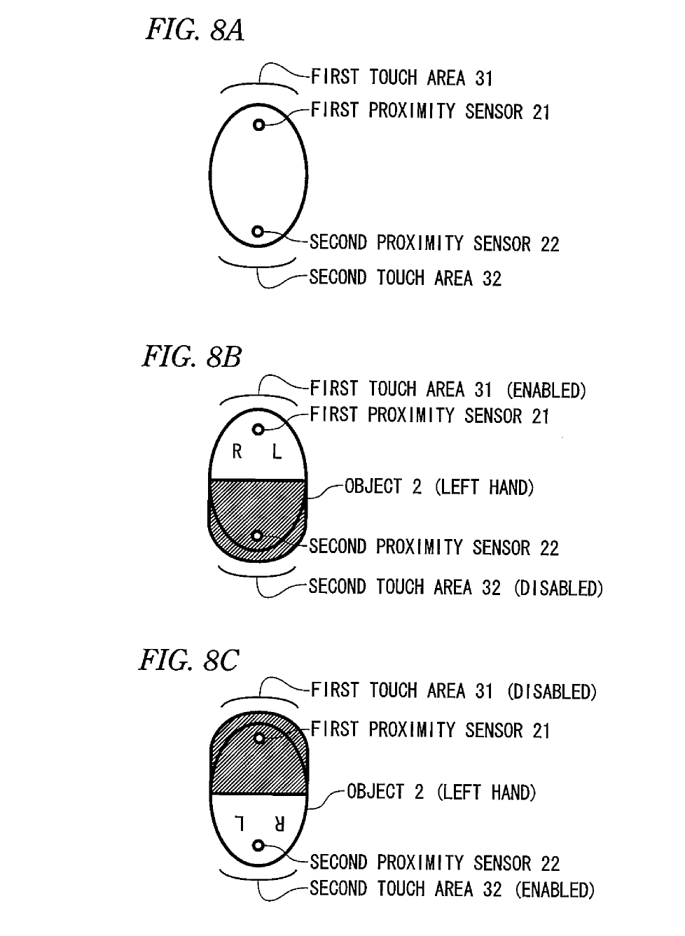

FIGS. 8A-8C illustrate the configuration and operations of a mouse 20 according to a further embodiment which is equipped with two proximity sensors and set for the left hand. In this embodiment, it is set in the notebook PC 10 in advance that if an object is detected by one of the proximity sensors the user will manipulate the mouse 20 with his or her left hand.

FIG. 8A shows the configuration of the mouse 20 according to the embodiment. As shown in FIG. 8A, the mouse 20 is equipped with two proximity sensors, that is, a first proximity sensor 21 and a second proximity sensor 22.

As described later, the mouse 20 is provided with two areas (touch areas), that is, a first touch area 31 and a second touch area 32, which perform different operations.

The mouse 20 according to the embodiment is equipped with a controller such as a CPU (not shown).

The first proximity sensor 21 is disposed in or in the vicinity of the first touch area 31 and detects an object that is located close to the mouse 20. Likewise, the second proximity sensor 22 is disposed in or in the vicinity of the second touch area 32 and detects an object that is located close to the mouse 20.

If an object is detected by the first proximity sensor 21, the controller enables the second touch area 32 and disables the first touch area 31.

FIG. 8B illustrates an operation that is performed when the user's left hand to manipulate the mouse 20 comes close to the mouse 20 and is detected as an object 1 by the second proximity sensor 22.

As mentioned above, in the embodiment, it is set in the notebook PC 10 in advance that if an object is detected by the second proximity sensor 22 the user will manipulate the mouse 20 with his or her left hand.

FIG. 8B shows a state that the object 1 has been detected by the second proximity sensor 22. In this case, the first touch area 31 is enabled and the second touch area 32 is disabled.

As shown in FIG. 8B, touch sensors L and R are rendered operational in the enabled first touch area 31. The touch sensor L corresponds to an area, to be usually manipulated by the index finger of the left hand, of the mouse 20 which is set for the left hand. The touch sensor R corresponds to an area, to be usually manipulated by the middle finger of the left hand, of the mouse 20.

FIG. 8C illustrates an operation that is performed when the user's left hand to manipulate the mouse 20 comes close to the mouse 20 and is detected as an object 1 by the first proximity sensor 21.

As mentioned above, in the embodiment, it is set in the notebook PC 10 in advance that if an object is detected by the first proximity sensor 21 the user will manipulate the mouse 20 with his or her left hand.

FIG. 8C shows a state that the object 1 has been detected by the first proximity sensor 21. In this case, the second touch area 32 is enabled and the first touch area 31 is disabled.

As shown in FIG. 8C, as in the case of FIG. 8B, touch sensors L and R are rendered operational in the enabled second touch area 32. The touch sensor L corresponds to an area, to be usually manipulated by the index finger of the left hand, of the mouse 20 which is set for the left hand. The touch sensor R corresponds to an area to be usually manipulated by the middle finger of the left hand, of the mouse 20.

As shown in FIGS. 8A-8C, the above configuration makes it possible to provide a mouse which can be used in plural (two) orientations.

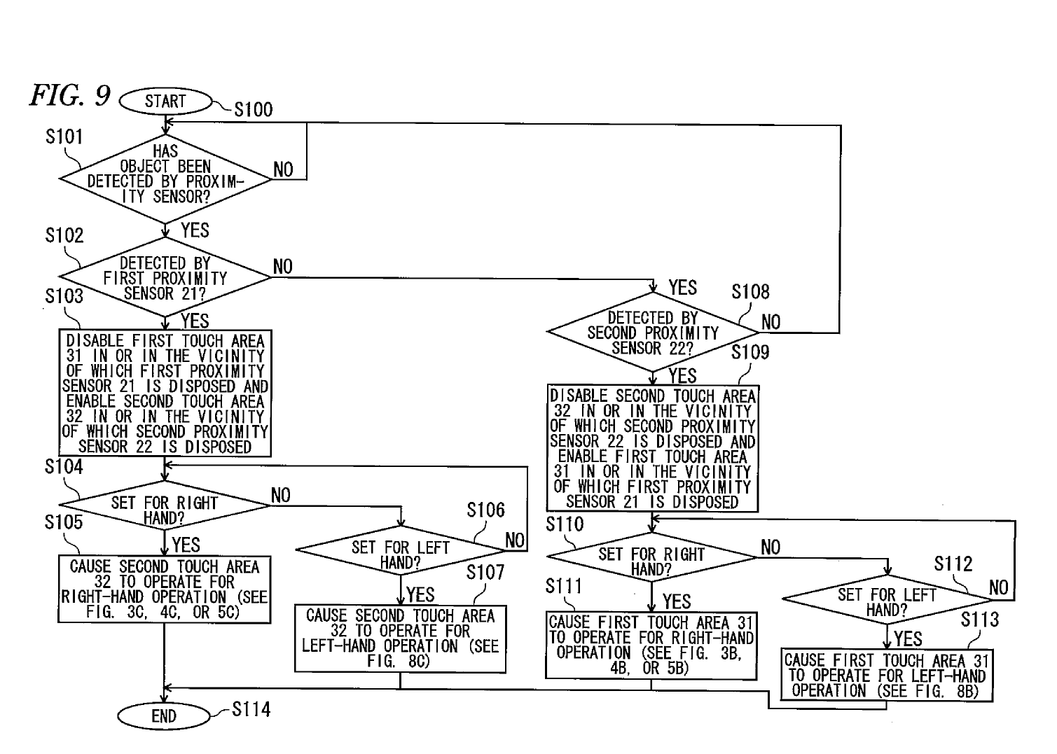

FIG. 9 is a flowchart of a process which is executed by each of the mice 20 having two proximity sensors.

The process is started at step S100. At step S101, it is judged whether or not an object has been detected by one of the two proximity sensors 21 and 22. If it is judged that an object has been detected by one of the two proximity sensors 21 and 22 (S101: yes), the process moves to step S102. If not (S101: no), step S101 is executed again.

At step S102, it is judged whether the proximity sensor that has detected the object is the first proximity sensor 21 or not. If it is judged that the proximity sensor that has detected the object is the first proximity sensor 21 (S102: yes), the process moves to step S103. If not (S102: no), the process moves to step S108.

At step S103, the first touch area 31 in or in the vicinity of which the first proximity sensor 21 is disposed is disabled and the second touch area 32 in or in the vicinity of which the second proximity sensor 22 is disposed is enabled.

At step S104, it is judged whether or not the mouse 20 is set for the right hand. If it is judged that the mouse 20 is set for the right hand (S104: yes), the process moves to step S105. If not (S104: no), the process moves to step S106.

At step S105, the second touch area 32 is caused to operate for right-hand operation in, for example, the manner shown in FIG. 3C, 4C, or 5C.

At step S106, it is judged whether or not the mouse 20 is set for the left hand. If it is judged that the mouse 20 is set for the left hand (S106: yes), the process moves to step S107. If not (S106: no), the process returns to step S104.

At step S107, the second touch area 32 is caused to operate for left-hand operation in, for example, the manner shown in FIG. 8C.

At step S108, it is judged whether the proximity sensor that has detected the object is the second proximity sensor 22 or not. If it is judged that the proximity sensor that has detected the object is the second proximity sensor 22 (S108: yes), the process moves to step S109. If not (S108: no), the process returns to step S101.

At step S109, the second touch area 32 in or in the vicinity of which the second proximity sensor 22 is disposed is disabled and the first touch area 31 in or in the vicinity of which the first proximity sensor 21 is disposed is enabled.

At step S110, it is judged whether or not the mouse 20 is set for the right hand. If it is judged that the mouse 20 is set for the right hand (S110: yes), the process moves to step S111. If not (S110: no), the process moves to step S112.

At step S111, the first touch area 31 is caused to operate for right-hand operation in, for example, the manner shown in FIG. 3B, 4B, or 5B.

At step S112, it is judged whether or not the mouse 20 is set for the left hand. If it is judged that the mouse 20 is set for the left hand (S111: yes), the process moves to step S113. If not (S112: no), the process returns to step S110.

At step S113, the first touch area 31 is caused to operate for left-hand operation in, for example, the manner shown in FIG. 8B.

The process is finished at step S114.

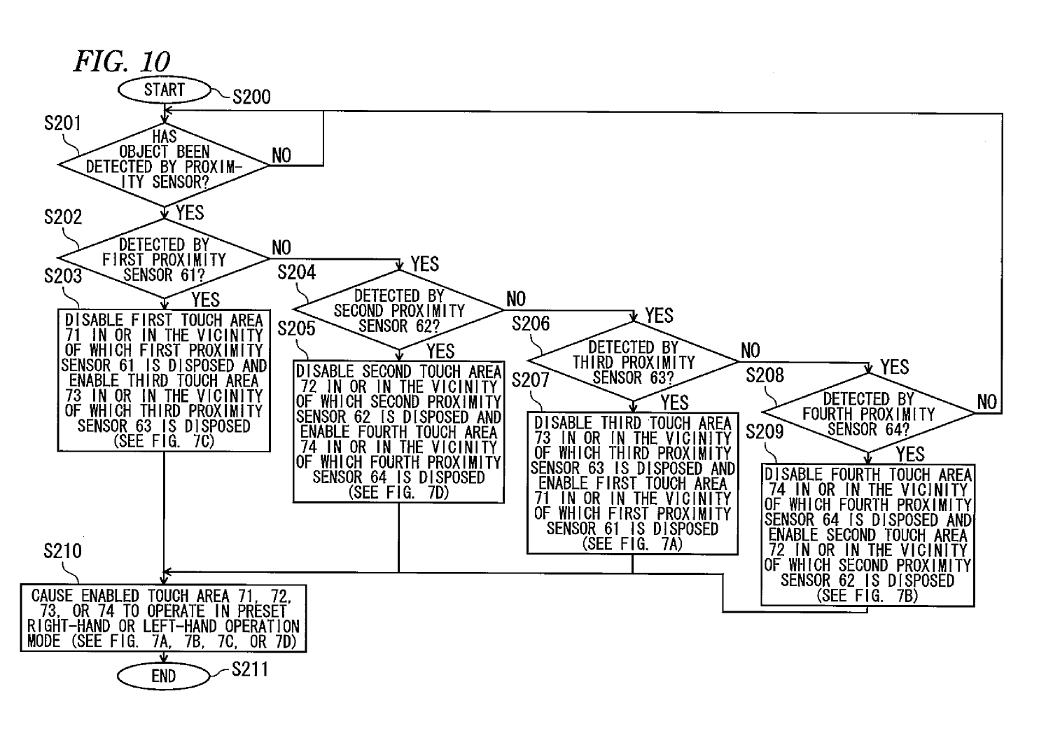

FIG. 10 is a flowchart of a process which is executed by the mouse 20 having four proximity sensors.

The process is started at step S200. At step S201, it is judged whether or not an object has been detected by one of the four proximity sensors 61-64. If it is judged that an object has been detected by one of the four proximity sensors 61-64 (S201: yes), the process moves to step S202. If not (S201: no), step S201 is executed again.

At step S202, it is judged whether the proximity sensor that has detected the object is the first proximity sensor 61 or not. If it is judged that the proximity sensor that has detected the object is the first proximity sensor 61 (S202: yes), the process moves to step S203. If not (S202: no), the process moves to step S204.

At step S203, the first touch area 71 in or in the vicinity of which the first proximity sensor 61 is disposed is disabled and the third touch area 73 in or in the vicinity of which the third proximity sensor 63 is disposed is enabled in the manner shown in FIG. 7C.

At step S204, it is judged whether the proximity sensor that has detected the object is the second proximity sensor 62 or not. If it is judged that the proximity sensor that has detected the object is the second proximity sensor 62 (S204: yes), the process moves to step S205. If not (S204: no), the process moves to step S206.

At step S205, the second touch area 72 in or in the vicinity of which the second proximity sensor 62 is disposed is disabled and the fourth touch area 74 in or in the vicinity of which the fourth proximity sensor 62 is disposed is enabled in the manner shown in FIG. 7D.

At step S206, it is judged whether the proximity sensor that has detected the object is the third proximity sensor 63 or not. If it is judged that the proximity sensor that has detected the object is the third proximity sensor 63 (S206: yes), the process moves to step S207. If not (S206: no), the process moves to step S208.

At step S207, the third touch area 73 in or in the vicinity of which the third proximity sensor 63 is disposed is disabled and the first touch area 71 in or in the vicinity of which the first proximity sensor 61 is disposed is enabled in the manner shown in FIG. 7A.

At step S208, it is judged whether the proximity sensor that has detected the object is the fourth proximity sensor 64 or not. If it is judged that the proximity sensor that has detected the object is the fourth proximity sensor 64 (S208: yes), the process moves to step S209. If not (S208: no), the process returns to step S201.

At step S209, the fourth touch area 74 in or in the vicinity of which the fourth proximity sensor 64 is disposed is disabled and the second touch area 72 in or in the vicinity of which the second proximity sensor 62 is disposed is enabled in the manner shown in FIG. 7B.

At step S210, the enabled touch area 71, 72, 73, or 74 is caused to operate in a preset right-hand or left-hand operation mode in the manner shown in FIG. 7A, 7B, 7C, or 7D.

The process is finished at step S211. With the above-described processes, each of the embodiments makes it possible to provide a mouse which can be used in plural orientations. All the steps of the control process according to each embodiment can be implemented by software. Therefore, the same advantages as provided by each embodiment can easily be provided merely by installing, in an ordinary computer, a program describing the steps of the control process according to each embodiment through a computer-readable storage medium and executing the installed program.

While certain embodiments have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the sprit of the invention. The accompanying claims and their equivalents are intended to cover such forms or modifications as would fall within the scope and sprit of the invention.

What is claimed is:

1. An input device comprising:
a first sensor in or near a first touch area of the input device, the first sensor configured to detect an object when the object is close to the first touch area;
a second sensor in or near a second touch area of the input device, the second sensor configured to detect the object when the object is close to the second touch area; and
a controller configured to enable the second touch area to operate as a user operation area when the first sensor detects the object.

2. The device of claim 1, wherein
the controller is configured to disable the first touch area from operating as the user operation area when the first sensor detects the object.

3. The device of claim 1, wherein
the controller is configured to enable the first touch area to operate as the user operation area when the second sensor detects the object.

4. The device of claim 3, wherein
the controller is configured to disable the second touch area from operating as the user operation area when the second sensor detects the object.

5. The device of claim 1, wherein the first sensor and the second sensor each comprise a proximity sensor.

6. The device of claim 1, further comprising:
a setting module configured to set the input device for a right hand or a left hand,
wherein the controller is configured to enable the second touch area to operate for the right hand when the setting module sets the input device for the right hand.

7. The device of claim 1, further comprising:
a setting module configured to set the input device for a right hand or a left hand,
wherein the controller is configured to enable the second touch area to operate for the left hand when the setting module sets the input device for the left hand.

8. A method of controlling an input device, the method comprising:
detecting an object with a first sensor when the object is close to a first touch area;
detecting the object with a second sensor when the object is close to a second touch area; and
enabling the second touch area to operate as a user operation area when the first sensor detects the object.

9. A non-transitory computer-readable medium that stores executable program instructions for causing an input device to perform a process that comprises:
detecting an object with a first sensor when the object is close to a first touch area;
detecting the object with a second sensor when the object is close to a second touch area; and
enabling the second touch area to operate as a user operation area when the first sensor detects the object.
